(19) United States
(12) Patent Application Publication
(10) Pub. No.: US 2026/0131301 A1
(43) Pub. Date: May 14, 2026

(54) LIGHT ENGINE BASED ON A LIGHTGUIDE FOR SPINNING DISK PHOTOCHEMISTRY REACTORS

(71) Applicant: SIGNIFY HOLDING B.V., EINDHOVEN (NL)

(72) Inventors: NORBERTUS ANTONIUS MARIA SWEEGERS, LIEROP (NL); REMY CYRILLE BROERSMA, EINDHOVEN (NL); ANNA WILHELMINA MARIA DE BEST, VELDHOVEN (NL); DANIËL ANTON BENOY, GELDROP (NL)

(21) Appl. No.: 19/119,198

(22) PCT Filed: Oct. 3, 2023
(86) PCT No.: PCT/EP2023/077303

§ 371 Date: Apr. 8, 2025

(30) Foreign Application Priority Data
Oct. 11, 2022 (EP) 22200933.4

(51) Int. Cl. B01J 19/18; B01J 19/12

(52) U.S. Cl. CPC B01J 19/1806; B01J 19/123; B01J 19/127; B01J 19/128; B01J 2219/0875; B01J 2219/0877

(57) ABSTRACT

The invention provides a photoreactor assembly (1000) comprising (i) a light source arrangement (700), (ii) a photochemical reactor (200), and (iii) a lightguide body arrangement (500); wherein: the light source arrangement (700) comprises one or more light sources (10); wherein the one or more light sources (10) are configured to generate light source radiation (11) selected from one or more of UV radiation, visible radiation, and IR radiation; the lightguide body arrangement (500) comprises a lightguide body (550) and a light escape face (571); wherein the lightguide body (550) comprises a first lightguide part (551) and a second lightguide part (552); wherein the lightguide body (550) and the light source arrangement (700) are configured such that at least part of the light source radiation (11) that enters the lightguide body (550) via the first lightguide part (551) escapes from the lightguide body (550) via the second lightguide part (552); wherein the light escape face (571) is (a) configured downstream of the second lightguide part (552) or (b) is comprised by the second lightguide part (552); the photochemical reactor (200) comprises a reactor chamber (210) configured to host a first fluid (5) to be treated with the light source radiation (11); wherein the photochemical reactor (200) comprises a reactor chamber wall (220) enclosing at least part of the reactor chamber (210); wherein the photochemical reactor (200) comprises a spinning disk reactor (201), wherein the spinning disk reactor (201) comprises a disk (250) at least partly configured in the reactor chamber (210); and the lightguide body arrangement (500) (a) penetrates the reactor chamber wall (220) at least partly into the reactor chamber (210) or (b) provides part of the reactor chamber wall (220).

### FIELD OF THE INVENTION

The invention relates to a photoreactor assembly comprising a light source arrangement, a photochemical reactor, and a lightguide body arrangement. The invention further relates to a method for treating a fluid with light source radiation using said photoreactor assembly.

### BACKGROUND OF THE INVENTION

Photoreactor assemblies are known in the art. For instance, US2016304368A1 describes an active photocatalytic reactor configured to process biological culturing water with an accelerated process. Water to be used in a biological culturing system is stabilized with pollutants in the water reduced. The active photocatalytic reactor is less affected by outside environment while having faster activating speed. The active photocatalytic reactor can further be combined with a traditional filter to form a serial or parallel connection for more effectively purifying the culturing water with damage to the whole system avoided.

U.S. Pat. No. 5,163,626 discloses a process for the decomposition of photocatalytically decomposable organic material which includes exposing the organic material to ultraviolet light as the material is passed across the surface of a spinning disc. The organic material is in the form of a liquid dispersion, preferably an aqueous dispersion and the dispersion also contains anatase titanium dioxide which acts as a catalyst in the decomposition process. Preferably the anatase titanium dioxide has a high surface area. Organic materials such as hydrocarbons, alcohols, acids, esters and others are destroyed in this environmentally acceptable process.

US2003161767 discloses a reactor including a rotatable disc having a region in an upper surface thereof. Reactant is supplied to the region by way of a feed, the disc is rotated at high speed, and the reactant moves from the region so as to form a film on the surface. As the reactant traverses the surface of the disc, it undergoes chemical or physical processes before being thrown from the periphery of the disc into collector means.

Stoller Marco et al. (2020) discloses ZnO nano-particles production intensification by means of a spinning Disk reactor.

Chaudhuri Arnab et al. (2020) discloses process intensification of a photochemical oxidation reaction using a rotor-stator spinning disk reactor and a strategy for scale up.

Huang H J et al. (2015) discloses plasmonic photocatalytic reactions enhanced by hot electrons in a one-dimensional quantum well.

KR20100021771 discloses a spinning disk reactor which comprises: an interactant feeder of one or more kind; a first disk which is formed based on rotary shafts and in which reaction of the reactant provided from the interactant feeder is advanced; a reactant supply passageway which is formed in order to supply the reactant on the first disk by transferring the reactant from the supply passageway; a second disk which surrounds the first disk and in which a thermal medium is formed; a product gathering unit collecting the product reacted on the first disk; and a driving part for rotating the rotary shaft and the first disk.

### SUMMARY OF THE INVENTION

Photochemical processing or photochemistry relates to the chemical effect of light. More in general photochemistry refers to a (chemical) reaction caused by absorption of light, especially ultraviolet light (radiation), visible light (radiation) and/or infrared radiation (light). Photochemistry may for instance be used to synthesize specific products. For instance, isomerization reactions or radical reactions may be initiated by light. Other naturally occurring processes that are induced by light are e.g. photosynthesis, or the formation of vitamin D with sunlight. Photochemistry may further e.g. be used to degrade/oxidize pollutants in water or e.g. air. Photochemical reactions may be carried out in a photochemical reactor or “photoreactor”.

One of the benefits of photochemistry is that reactions can be performed at lower temperatures than conventional thermal chemistry and partly for that reason thermal side reactions that generate unwanted by-products are avoided.

Furthermore, commonly used light sources in photochemistry may include low or medium pressure mercury lamps or fluorescent lamps. In addition to that, some reactions may require a very specific wavelength region, and they may even be hampered by light from the source emitted at other wavelengths. In these cases, part of the spectrum may have to be filtered out, which may lead to a low efficiency and complex reactor design.

In the recent years the output of Light Emitting Diodes (LEDs), both direct LEDs with dominant wavelengths ranging for instance from UVC to IR wavelengths, and phosphor-converted LEDs, has increased drastically, making them interesting candidates for light sources for photochemistry. High fluxes can be obtained from small surfaces, especially if the LEDs can be kept at a low temperature.

Spinning disk reactors are a type of chemical reactor used because the small area between a fast rotating disc and the reactor wall may result in very high mixing performance. High gaseous or liquid pressures occur for chemical processes in such spinning disk reactors. The high mixing performance and high pressure may result in a high efficiency of the chemical reaction. However, for photochemical reactors, a spinning disk reactor appears not to be commercially available yet, as the high pressures can cause breaking of the transparent window separating the light sources from the reactor chamber. In the chemical and pharmaceutical industry such an explosive environment with organic substances is highly unwanted due to safety concerns.

Previous developments on producing a safe yet efficient photochemical reactor with a spinning disk have focused on providing stronger support structures for the light sources which may serve to shield them from the potentially hazardous conditions within the reactor, or replacing/removing sensitive parts such as electrical supply wiring. However, in such photoreactor assemblies the light sources remain in close proximity to the reactor and hence potential exposure to hazardous conditions. Hence, it is an aspect of the invention to provide an alternative photoreactor assembly, which preferably further at least partly obviates one or more of above-described drawbacks. The present invention may have as object to overcome or ameliorate at least one of the disadvantages of the prior art, or to provide a useful alternative.

According to a first aspect, the invention provides a photoreactor assembly (also: “reactor assembly” or “assembly”). Such a photoreactor assembly may in embodiments especially comprise a light source arrangement, a photochemical reactor, and a lightguide body arrangement. The light source arrangement may comprise one or more light sources.

Especially, the one or more light sources may be configured to generate light source radiation (or: “light source light”). Such light source radiation may be selected from one or more of ultraviolet (“UV”) radiation, visible radiation, and infrared (“IR”) radiation. The lightguide body arrangement may comprise a lightguide body. The lightguide body arrangement may further comprise a light escape face. The lightguide body may comprise a first lightguide part and a second lightguide part. Especially, the lightguide body and the light source arrangement may be configured such that at least part of the light source radiation that enters the lightguide body via the first lightguide part may escape from the lightguide body via the second lightguide part. In certain embodiments, the light escape face may be configured downstream of the second lightguide part. In other embodiments, the light escape face may be comprised by the second lightguide part. The photochemical reactor may comprise a reactor chamber. Such a reactor chamber may be configured to host a first fluid (also: “reactor fluid” or “reactor chamber fluid”) to be treated with the light source radiation. The photochemical reactor may comprise a reactor chamber wall. Such reactor chamber wall may enclose at least part of the reactor chamber. The photochemical reactor may especially comprise a spinning disk reactor. Such a spinning disk reactor may comprise a disk (also: “spinning disk” or “reactor disk” or “rotatable disk”) at least partly configured in the reactor chamber. In certain embodiments, the lightguide body arrangement may penetrate the reactor chamber wall at least partly into the reactor chamber. In other embodiments, the lightguide body arrangement may provide part of the reactor chamber wall. Therefore, in embodiments the invention provides a photoreactor assembly comprising (i) a light source arrangement, (ii) a photochemical reactor, and (iii) a lightguide body arrangement; wherein: the light source arrangement comprises one or more light sources; wherein the one or more light sources are configured to generate light source radiation selected from one or more of UV radiation, visible radiation, and IR radiation; the lightguide body arrangement comprises a lightguide body and a light escape face; wherein the lightguide body comprises a first lightguide part and a second lightguide part; wherein the lightguide body and the light source arrangement are configured such that at least part of the light source radiation that enters the lightguide body via the first lightguide part escapes from the lightguide body via the second lightguide part; wherein the light escape face is (a) configured downstream of the second lightguide part or (b) is comprised by the second lightguide part; the photochemical reactor comprises a reactor chamber configured to host a first fluid to be treated with the light source radiation; wherein the photochemical reactor comprises a reactor chamber wall enclosing at least part of the reactor chamber; wherein the photochemical reactor comprises a spinning disk reactor, wherein the spinning disk reactor comprises a disk at least partly configured in the reactor chamber; and the lightguide body arrangement (a) penetrates the reactor chamber wall at least partly into the reactor chamber or (b) provides part of the reactor chamber wall.

With the present invention, a photoreactor assembly may be provided comprising e.g. a lightguide body arrangement (comprising a lightguide body). The use of a lightguide body to guide light source radiation from the one or more light sources (that may be positioned external to the chemical reaction chamber or the reactor) to the light escape face that is positioned inside the reaction chamber may ensure a hermetically sealed light source arrangement that may be resistant to nearly any pressure within the reaction chamber during operation. There may also be no need for power supply cables in close proximity to the reactor which may be sensitive to heat and corrosive liquids in a chemical environment. Further, the cooling of the light source arrangement may be configured outside of the reactor and therefore the reaction temperatures may not influence the efficiency of the light sources as well as the temperature of the light sources do not influence the reaction kinetics. Hence, such photoreactor assembly may provide high photocatalytic efficiency with minimal safety concerns.

Further, in specific embodiments, further comprising a spinning disk reactor, such photoreactor assembly may be able to treat a fluid in the reactor chamber with the light source radiation with high mixing performance and high pressure due to a treatment of the first fluid in the reaction chamber. The high mixing performance and high pressure may result in a high efficiency process of the chemical reaction. The use of a lightguide body arrangement to provide light to the reactor chamber may ensure that the light source arrangement may be external to the reactor chamber, and thereby shielded from the potentially hazardous conditions in the reactor chamber i.e. high pressure, vibrating motion, corrosive liquids, etc. This may be particularly desirable with regards to safety concerns in the chemical and pharmaceutical industry associated with the use of photochemical spinning disk reactors. Hence, such photoreactor assembly may provide a high efficiency process of the chemical reaction with minimal safety concerns.

As indicated above, the invention provides a photoreactor assembly. In embodiments, the photoreactor assembly may comprise a light source arrangement, a photochemical reactor, and a lightguide body arrangement, which will further be discussed below.

The light source arrangement may comprise one or more light sources, especially solid state light sources, configured to generate light source radiation selected from one or more of UV radiation, visible radiation, and IR radiation. The light source arrangement may in embodiments be configured outside of the reaction chamber. Especially, in embodiments the light source arrangement may be configured outside of the reactor. Hence, the light source arrangement may be shielded away from the potentially hazardous and/or challenging conditions in the reaction chamber during operation. Further, this may facilitate ease of adjustment, maintenance, and replacement of the light source arrangement in between modes of operation of the photoreactor assembly.

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to visible light. In embodiments, the light source radiation may comprise UV radiation. The light source radiation may in further embodiments (also) comprise visible radiation. In yet further embodiments, the light source radiation may (also) comprise IR radiation. The term “UV radiation” is known to the person skilled in the art and relates to “ultraviolet radiation”, or “ultraviolet emission”, or “ultraviolet light”, especially having one or more wavelengths in the range of about 10-380 nm. In embodiments, UV radiation may especially have one or more wavelength in the range of about 100-380 nm, such as selected from the range of 190-380 nm. Moreover, the term “UV radiation” and similar terms may also refer to one or more of UVA, UVB, and UVC radiation. UVA radiation may especially refer to having one or more wavelengths in the range of about 315-380 nm. UVB radiation may especially refer to having one or more wavelengths in the range of about 280-315 nm. UVC radiation, may further especially have one or more wavelengths in the range of about 100-280 nm. In embodiments, the light sources may be configured to provide light source radiation having wavelengths larger than about 190 nm. In embodiments, the light source radiation may include wavelengths in the 380-400 nm, which is in the art sometimes indicated as part of the UVA and in other art as part of the visible wavelength range.

The terms “visible”, “visible light”, “visible emission”, or “visible radiation” and similar terms refer to light having one or more wavelengths in the range of about 380-780 nm. The term “IR radiation” especially relates to “infrared radiation”, “infrared emission”, or “infrared light”, especially having one or more wavelengths in the range of 780 nm to 1 mm. Moreover, the term “IR radiation” and similar terms may also refer to one or more of NIR, SWIR, MWIR, LWIR, FIR radiation. NIR may especially relate to Near-infrared radiation having one or more wavelength in the range of about 750-1400 nm, such as 780-1400 nm. SWIR may especially relate to Short-wavelength infrared having one or more wavelength in the range of about 1400-3000 nm. MWIR may especially relate to Mid-wavelength infrared having one or more wavelength in the range of about 3000-8000 nm. LWIR may especially relate to Long-wavelength infrared having one or more wavelength in the range of about 8-15 μm. FIR may especially relate to Far infrared having one or more wavelength in the range of about 15-1000 μm.

In embodiments, the one or more light sources may comprise a plurality of light sources. Further, the light sources may especially comprise solid state light sources.

The term “light source” may in principle relate to any solid state light source known in the art. In a specific embodiment, the light source comprises a solid state LED light source (such as a LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a printed circuit board (or: “PCB”). Hence, a plurality of light emitting semiconductor light source may be configured on the same substrate. In embodiments, a COB is a multi LED chip configured together as a single lighting module.

The light source may have a light escape surface. Referring to LEDs it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source. Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc. The term “light source” may also refer to an organic light-emitting diode (OLED), such as a passive-matrix (PMOLED) or an active-matrix (AMOLED). In a specific embodiment, the light source comprises a solid-state light source (such as a LED or laser diode). In an embodiment, the light source comprises a LED (light emitting diode). The terms “light source” or “solid state light source” may also refer to a superluminescent diode (SLED).

The term LED may also refer to a plurality of LEDs. In embodiments, the light source may comprise one or more micro-optical elements (array of micro lenses) downstream of a single solid-state light source, such as a LED, or downstream of a plurality of solid-state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation.

Secondary radiation may be based on conversion by a luminescent material. The secondary radiation may therefore also be indicated as luminescent material radiation. The luminescent material may in embodiments be comprised by the light source, such as a LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as a LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material.

The light source may especially be configured to generate light source light having an optical axis (O), (a beam shape,) and a spectral power distribution. The light source light may in embodiments comprise one or more bands, having band widths as known for lasers.

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device). The term “light source” herein may also refer to a light source comprising a solid state light source, such as an LED or a laser diode or a superluminescent diode. The “term light source” may (thus) in embodiments also refer to a light source that is (also) based on conversion of light, such as a light source in combination with a luminescent converter material. Hence, the term “light source” may also refer to a combination of a LED with a luminescent material configured to convert at least part of the LED radiation, or to a combination of a (diode) laser with a luminescent material configured to convert at least part of the (diode) laser radiation. In embodiments, the term “light source” may also refer to a combination of a light source, like a LED, and an optical filter, which may change the spectral power distribution of the light generated by the light source. Especially, the “term light generating device” may be used to address a light source and further (optical components), like an optical filter and/or a beam shaping element, etc. The term “solid state light source”, or “solid state material light source”, and similar terms, may especially refer to semiconductor light sources, such as a light emitting diode (LED), a diode laser, or a superluminescent diode.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The one or more light sources may generate heat alongside light source radiation during operation. As a consequence, the one or more light sources may sustain relatively high temperatures, such as over 60° C., especially over 80° C., moreover over 100° C. This may especially be the case when during operation the one or more light sources are providing light source radiation at high radiant power, such as over 100 W, especially over 200 W, moreover over 400 W, specifically over 1000 W. This may additionally be the case when during operation the one or more light sources are providing light source radiation for an extended duration of time, such as over 2 hours, especially over 5 hours, moreover over 10 hours. Exposure to high temperatures may negatively affect the one or more light sources, as this may lead to a reduction in the luminous power of the one or more light sources and may reduce the lifetime of the one or more light sources.

To compensate for the heat generation of the one or more light sources, the light source arrangement may comprise a cooling system. Such a cooling system may comprise one or more of liquid cooling, convection cooling, and conduction cooling. The cooling system may facilitate keeping the one or more light sources at relatively low temperatures, such as below 80° C., especially below 60° C., moreover below 40° C. In the context of the present invention, the cooling system may be placed external to the reaction chamber, especially external to the reactor, to be configured in close proximity to the light source arrangement. Hence, the cooling system may not be affected by the (high) temperatures inside of the reaction chamber and/or the reactor. Vice versa, the (high) temperatures inside of the reaction chamber and/or the reactor may not be affected by the cooling system.

As indicated above, the invention provides a photoreactor assembly comprising a photochemical reactor. The term “reactor” may especially relate to a (photo)chemical reactor. The term may essentially relate to an enclosed (reactor) chamber in which a (photochemical) reaction may take place. The (photochemical) reaction may take place due to irradiation of a fluid with the light source radiation.

In further embodiments, the photochemical reactor may comprise a reactor chamber further comprising a flow reactor system. In embodiments, the reactor chamber may be configured downstream from the light source arrangement. In embodiments, the flow reactor system may comprise a reactor channel, through which the first fluid may be flown. In embodiments, the flow reactor system may be configured to react one or more reactor fluid(s) within flow reactor cells in the reactor channel or comprised by the reactor channel. In further embodiments, the one or more chemicals flown through the flow reactor cells may (also) be reacted with the light source radiation irradiated on the one or more chemicals. The flow reactor system may be configured for hosting the (reactor) fluid to be treated, especially with light source radiation. In embodiments, the flow reactor system may be configured in a radiation receiving relationship with (at least part of) the plurality of light sources. Hence, the first fluid may be transported through the flow reactor system and at least part of the flow reactor system may be irradiated with the radiation.

More especially, the flow reactor system may comprise one or more channels and optionally one or more reaction chamber in fluid contact with the one or more channels. The radiation may be provided to at least part of the one or more channels, or, when one or more reaction chambers are available, alternatively or additionally to the one or more reaction chambers. A reaction chamber may comprise a flow reactor cell. However, the reactor chamber may also be channel, or a part of the channel. Hence, in embodiments the reactor chamber may be channel, having essentially the same cross-sectional dimensions as an upstream channel part and a downstream channel part. However, in other embodiments, such as in the case of a spinning disk reactor, the reactor chamber may have cross-sectional dimensions different from an upstream channel (part) and/or a downstream channel (part).

The reactor fluid may comprise one or more of a liquid and a gas. The term “fluid” may also refer to a combination of two or more different fluids. When the reactor fluid comprises a liquid, the liquid may comprise one liquid or two or more different liquids. The liquid may in embodiments also comprise particulate material. When the reactor fluid comprises a gas, the gas may comprise one type of gas or two or more types of different gasses. The fluid may comprise particulate catalyst material or may comprise a homogenous catalyst, but may in other embodiments also comprise no catalyst. The fluid may comprise an emulsion. The reactor fluid may comprise at least one or more reactants. Reactants are chemical substances that may take part in the (photo)chemical reaction. The one or more reactants may undergo a chemical change as the (photo)chemical reaction takes place to provide a chemical product. When the (photo)chemical reaction has completed, at least part of the one or more reactants may have become the chemical product. Especially, the reactor fluid may comprise at least two or more reactants, which during the (photo)chemical reaction react with one or more of the other reactants to provide at least one or more chemical product.

In certain embodiments, the photochemical reactor may comprise a catalyst. The catalyst is a chemical substance that does not undergo a chemical change as the (photo)chemical reaction takes place. The catalyst may in embodiments improve the reaction rate of the (photo)chemical reaction. The catalyst may in specific embodiments facilitate the (photo)chemical reaction. As the catalyst does not undergo a chemical change, it may be used over multiple (photo)chemical reactions. The catalyst may be immobilized on part of the reactor chamber and/or on the disk (in the case of a spinning disk reactor).

Chemical reactions in reactors are known to the person skilled in the art. Further, the irradiation with radiation may in embodiments lead to a chemical reaction, which may also include a dissociation (see further also below).

The photochemical reactor may comprise a reactor chamber wall. The reactor chamber wall may enclose at least part of the reactor chamber. The reactor chamber wall may enclose essentially the entire reactor chamber (in embodiments except e.g. an inlet/outlet, and in specific embodiments except e.g. an axle part (see also below)). The reactor chamber wall may comprise a material able to withstand the conditions within the reactor chamber, i.e., high pressure, vibrating motion, corrosive liquids, etc. Such reactor chamber wall material may be selected from the group comprising metals, glasses, ceramics, polymers, carbon, and composites. Especially, the reactor chamber wall material may comprise a hard metal coating (e.g. Hastelloy, tungsten-based alloys), polytetrafluoroethylene, or high-quality low-alloy carbon steel. Hence, the reactor chamber wall provides a durable and safe enclosure of the reactor chamber, especially a durable and safe enclosure of the reactor chamber during operation.

In specific embodiments, the photochemical reactor may comprise a spinning disk reactor. The spinning disk reactor may comprise a rotatable spinning disk. Such spinning disk may consist of two main parts: a wheel part (or: “wheel”) and an axle part (or: “axle”). In embodiments, the wheel part of the spinning disk may be rotatable around a fixed axis defined by the axle part. The axle part may be connected to a further mechanical system comprised by the rotor (described further below). As the mechanical system comprised by the rotor rotates, it may drive the rotation of the axle and wheel parts of the spinning disk.

The spinning disk may be at least partly configured in the reaction chamber. In embodiments, at least the wheel part of the spinning disk may be configured entirely in the reaction chamber. Further, the spinning disk comprising the wheel part and axle part may be entirely configured within the reaction chamber. In other embodiments, at least part of the axle part may be configured outside of the reaction chamber. Moreover, the axle part may at least partly be configured entirely outside of the reaction chamber. For instance, the axle part may penetrate a chamber wall. In the case of multiple reaction chambers, configured in a 1D array, the axle part may be configured through the reaction chambers, with multiple disks, with each reaction chamber comprising one of the disks.

The rotational speed of the spinning disk may in embodiments be controlled (with a control system; see also below). In embodiments, the spinning disk may be under on-off control, with a single rotational speed being available when the spinning disk is turned on. In other embodiments, the spinning disk may be able to operate at multiple speed settings when the spinning disk is turned on. In further embodiments, the rotational speed of the spinning disk may increase or decrease in gradual advancement when the spinning disk is turned on. In embodiments, the spinning disk may be turned on for at least part of the duration of the (photo)chemical reaction. Especially, the spinning disk may be turned on for the entire duration of the (photo)chemical reaction. In other embodiments, the spinning disk may be turned on for a specific duration during the (photo)chemical reaction and turned off after that duration. Further, the spinning disk may be turned on and off at least twice or more during the (photo)chemical reaction.

In embodiments, the spinning disk may have at least one or more rotational speeds during the (photo)chemical reaction. In specific embodiments, especially those wherein the spinning disk only has an on-off control, the spinning disk may retain the same rotational speed during the (photo)chemical reaction. In other embodiments, the spinning disk may change rotational speed at least once or more during the (photo)chemical reaction. In such embodiments where the spinning disk is turned on and off multiple times at least twice or more during the (photo)chemical reaction, the spinning disk may have different rotational speeds. In embodiments, the range of the rotational speed of the spinning disk may be 180°/s-36000°/s, such as 360°/s-36000°/s. The range of the rotational speed may especially be 540°/s-36000°/s, such as 540°/s-27000°/s. In embodiments, the range of the rotational speed may be 720°/s-27000°/s, and may especially be 720°/s-18000°/s. Further, the range of the rotational speed may be 1080°/s-36000°/s, such as 1080°/s-18000°/s. Moreover, the range of the rotational speed may be 1440°/s-18000°/s, such as 1440°/s 9000°/s.

Through the rotation of the spinning disk, especially the wheel part of the spinning disk, the spinning disk may exert a force on the reactor chamber and/or the fluid in the reactor chamber. This force may result in (i) mixing the first fluid with high efficiency and (ii) increasing the reactor chamber pressure. Mixing the first fluid with high efficiency may result in improved reaction rate and may hence facilitate the reaction to reach equilibrium faster. Increasing the reactor chamber pressure may likewise result in an improved reaction rate and may hence facilitate the reaction to reach equilibrium faster.

In other embodiments, the photochemical reactor may instead comprise a flow reactor. The flow reactor may comprise a reactor channel, through which the first fluid may be flown. In embodiments, the flow reactor may be configured to react one or more rector fluid(s) within flow reactor cells in the reactor channel or comprised by the reactor channel. In further embodiments, the one or more chemicals flown through the flow reactor cells may (also) be reacted with the light source light irradiated on the one or more chemicals. The flow reactor may be configured for hosting the (reactor) fluid to be treated, especially with light source light. In embodiments, the flow reactor system may be configured in a radiation receiving relationship with (at least part of) the plurality of light sources. Hence, a fluid may be transported through the flow reactor system and at least part of the flow reactor system may be irradiated with the radiation.

Within the context of a photochemical reactor, the photochemical reaction of the first fluid may be driven by exposure to light generated by the light source. Mixing the first fluid with high efficiency may result in a more even dispersion of the various compounds in the first fluid and hence more even exposure to the light source light, especially in those embodiments wherein the light source light may not penetrate evenly throughout the reactor chamber. Hence the mixing by the spinning disk in the case of a spinning disk reactor may result in an improved reaction rate.

In other embodiments, the reaction driven by the photochemical reactor may comprise a multistep reaction. Especially, such a multistep reaction may comprise at least two or more (photo)chemical reactions. In such embodiments, at least one or more of the two or more (photo)chemical reactions may be a photochemical reaction. In embodiments wherein one or more of the (photo)chemical reactions is not a photochemical reaction and the reactor is a spinning disk reactor, the increased pressure in the reactor chamber by the spinning disk may improve the reaction rate of the one or more reaction steps that is not a photochemical reaction.

In photochemical reactors, the reactor chamber may during operation comprise conditions such as variations in temperature, variations in pressure, fluid flow, and corrosive reactants. This may especially be the case in photochemical reactors comprising a spinning disk reactor, which may present considerable variations in pressure and fluid flow. On the other hand, the light source arrangement in photochemical reactors may comprise materials and/or components sensitive to such conditions. Hence, it may be desirable to design a photochemical reactor configured to shield the light source arrangement from potentially hazardous conditions in the reactor chamber.

The current invention may in embodiments provide a photoreactor assembly comprising a lightguide body arrangement. Such a lightguide body arrangement may comprises a lightguide body. In specific embodiments, the lightguide body arrangement essentially consists of the lightguide body, though in other embodiments, there may e.g. be a further window (see also below). For instance, at least part of the lightguide body may be configured in a cavity. Such cavity may comprise a cavity wall which may be transmissive for at least part of the radiation escaping from the lightguide body.

The lightguide body may in embodiments be configured to receive light source light from the light source arrangement. The light source light may subsequently be transmitted through the lightguide body. Finally, the light source light may be outcoupled from the lightguide body, especially into the reactor chamber or into a light transmissive window (described further below). Hence, the lightguide body may facilitate transmission of light source light to the reactor chamber in the photochemical reactor while shielding the light source arrangement from the reactor chamber. In particular embodiments, the lightguide body may be a monolithic body from a material transmissive for light source light, especially transparent. In specific embodiments, this may preferably be a solid transparent material, i.e., a glass, mineral, polymeric material, or alternatives for such materials. Especially, the light transmissive material may be selected from the group comprising quartz, sapphire, borosilicate glass, soda lime glass, mineral glass, laminated glass, and coated glass.

In embodiments, the lightguide body may comprise a first lightguide part and a second lightguide part. The first lightguide part may be in a light-receiving relationship with the light source arrangement, especially the one or more light sources. The reactor chamber may be in a light-receiving relationship with the second lightguide part. Hence, the first lightguide part and the second lightguide part may be spatially separated parts of the lightguide body. For instance, assuming two perpendicularly configured faces of the lightguide body, a first face may at least partly be comprised by the first lightguide part, and a second face may at least partly be comprised by the second lightguide part.

The terms “light-receiving relationship” or “light receiving relationship”, and similar terms, may indicate that an item may during operation of a source of light (like a light generating device or light generating element or light generating system) may receive light from that source of light. Hence, the item may be configured downstream of that source of light. Between the source of light and the item, optics may be configured. The terms “upstream” and “downstream”, such as in the context of propagation of light, may especially relate to an arrangement of items or features relative to the propagation of the light from a light generating element (here the especially the (solid state) light source), wherein relative to a first position within a beam of light from the light generating element, a second position in the beam of light closer to the light generating element (than the first position) is “upstream”, and a third position within the beam of light further away from the light generating element (than the first position) is “downstream”. For instance, instead of the term “light generating element” also the term “light generating means” may be applied.

The lightguide body arrangement and the light source arrangement may especially be configured such that at least part of the light source radiation, or especially essentially all of the light source radiation, enters the lightguide body via the first lightguide part. At least part of that light source radiation, especially a substantial part of that light source radiation, may then escape from the lightguide body via the second lightguide part and hence be provided to the reactor chamber. Hence, the first lightguide part may comprise a light incoupling face. Therefore, the lightguide body arrangement may facilitate providing light source radiation to the reaction chamber while the light source arrangement may be located external to the reaction chamber or even the reactor. Such a configuration may minimize the risk of exposing the light source arrangement to the hazardous conditions within the reaction chamber during operation or even in the case of malfunction.

The light transmissive material of the lightguide body may be selected based on various factors: (i) the ability of the light transmissive material (especially as part of the first lightguide part) for the incoupling of light source light into the lightguide body; (ii) the ability of the light transmissive material to transmit light source radiation through the lightguide body; (iii) the ability of the light transmissive material (especially as part of the second lightguide part) for the outcoupling of light source light into the reactor chamber or the light transmissive window; and (iv) the ability to withstand the conditions present in the reactor chamber. In embodiments, the lightguide body may essentially comprise a monolithic body and hence the first lightguide part may comprise essentially the same light transmissive material as the second lightguide part. Further, the light transmissive material may yet be selected based on further factors, such as cost-effectiveness or availability. Especially, the lightguide body (comprising the first lightguide part and the second lightguide part) may be a monolithic body, such as a body of light transmissive material, especially light transparent material, like a bar or a fiber (or a rod). In certain embodiments, the lightguide body may in such embodiments comprise a flat (polygonal) disk shape. The lightguide body may in other embodiments comprise at least part of a lightguide bar, or a disk, or a fiber, or a rod. Moreover, the lightguide body may comprise an entire lightguide bar, or a disk, or a fiber, or a rod.

The lightguide body arrangement may further comprise a light escape face. In specific embodiments, the lightguide body may be in (direct) contact with the reaction chamber. In such embodiments, the light escape face may be comprised by the second lightguide part, and at least part of the surface of the lightguide body may provide the light escape face. In other embodiments, the light escape face may be configured downstream of the second lightguide part. Especially, in such embodiments the lightguide body may be shielded from the reaction chamber by a light transmissive window. The light transmissive window may be configured within a cavity or chamber in the reactor chamber and may optionally enclose at least part of the light guide body, especially spatially separating the lightguide body from the reactor chamber. In such embodiments, at least part of the surface of the light transmissive window may provide the light escape face.

Thus in certain embodiments the second lightguide part may at least partly comprise the escape face, especially the entire escape face. In other embodiments the second lightguide part may not comprise the escape face which may be comprised by a light transmissive window. In such embodiments, the second lightguide part may comprise another face, such as f.e. a slanted face (described further below), which may be reflective to light source light. Hence, the light escape face may comprise the surface area from which the light source radiation escapes from the lightguide body arrangement or the light transmissive window into the reactor chamber. Hence, in embodiments radiation of the light source(s) may propagate via the light escape face into the flow reactor system (comprised by the reactor chamber).

As indicated above, the lightguide body and the (optional) light transmissive window may comprise light transmissive materials. In embodiments where the lightguide body arrangement is at least partly enclosed by a light transmissive window, the lightguide body and the light transmissive window may comprise different light transmissive materials (though this is not necessarily the case). The light transmissive window material may be selected based on various factors: (i) the ability of the light transmissive window material for the incoupling of light source light into the lightguide transmissive window; (ii) the ability of the light transmissive window material to transmit light source radiation through the light transmissive window; (iii) the ability of the light transmissive material for the outcoupling of light source light into the reactor chamber; and (iv) the ability to withstand the conditions present in the reactor chamber. Further, the light transmissive window material may yet be selected based on further factors, such as cost-effectiveness or availability. The light transmissive window material may especially be high quality hard glass or high quality hard quartz.

In certain embodiments, the lightguide body arrangement may penetrate the reactor chamber wall at least partly into the reactor chamber. In the case of a spinning disk reactor, this may especially be arranged such that it interferes minimally with the operation of the spinning disk photochemical reactor, e.g. such that it minimally affects fluid dynamics in the reactor chamber. With such arrangement, the reactor chamber may be illuminated by light source radiation from within the reactor chamber.

In other embodiments, the lightguide body arrangement may provide at least part of the reactor chamber wall. Such reactor chamber wall may be positioned parallel or orthogonal relative to the positioning of the spinning disk. In such embodiments, the reactor chamber may be illuminated by light source radiation emanating from at least one or more of the reactor chamber walls. Especially, two reactor chamber walls opposite one another may be at least partly comprised by at least two or more lightguide body arrangements, thereby providing illumination of the first fluid contained within the reactor chamber from two opposite sides.

In specific embodiments, the lightguide body arrangement may provide essentially at least one reactor chamber wall. Especially, the reactor chamber wall positioned parallel to the positioning of the spinning disk may be comprised by the lightguide body arrangement in embodiments. In further embodiments, two reactor chamber walls opposite one another may be comprised by at least two or more lightguide body arrangements, thereby providing illumination of the first fluid contained within the reactor chamber from two opposite sides.

As described above, in specific embodiments, the lightguide body may provide the light escape face, whereas in other embodiments, a light transmissive window may provide the light escape face.

Further, in embodiments, the reactor chamber may comprise a chamber cross-sectional plane (P_{C}). In spinning disk photochemical reactors, the chamber cross-sectional plane P_{C} may generally relate to a plane perpendicular to a rotational axis of the spinning disk.

In certain embodiments, during operation the wheel of the spinning disk may be positioned orthogonal to the direction of gravity, i.e. the chamber cross-sectional plane P_{C} may be orthogonal to the direction of gravity. In other embodiments, the wheel of the spinning disk may be positioned parallel to the direction of gravity, i.e. the chamber cross-sectional plane P_{C} may be positioned parallel to the direction of gravity. Further embodiments may provide the wheel of the spinning disk positioned at various angles relative to the direction of gravity, and the chamber cross-sectional plane P_{C} may in each case take such angle.

In general, the reactor chamber may be arranged such that two reaction chamber wall parts of the reaction chamber wall of the reactor chamber may be aligned parallel to the chamber cross-sectional plane P_{C} and define a reaction chamber height H_{C}. Other reaction chamber wall parts may be aligned orthogonal to the chamber cross-sectional plane P_{C}.

The lightguide body arrangement may comprise an axis of elongation (A_{LB}). The lightguide body may especially be positioned such that it is elongated along the axis of elongation A_{LB}. The lightguide body may in some embodiments (i.e. when the lightguide body comprises a lightguide bar or a lightguide fiber) comprise a height and a length. In other embodiments (i.e. when the lightguide body comprises a circular lightguide body or a polygonal lightguide body), the lightguide body may comprise a height and a diameter. The axis of elongation may especially be parallel to the length or diameter of the lightguide body and orthogonal to the height of the lightguide body. Especially, the length or the diameter may be larger than the height, such as at least two times higher. The axis of elongation A_{LB} may in embodiments be configured parallel to the chamber cross-sectional plane P_{C}. In such way, in the case of a spinning disk reactor, the axis of elongation A_{LB} may be positioned similar to the spinning disk of the reactor chamber. Thereby, the flow of the first fluid driven by the spinning disk may align with the axis of elongation A_{LB}, hence facilitating illumination of the first fluid by the lightguide body arrangement. This may hence result in improved efficiency of the photocatalytic reaction.

Further, the light source arrangement may comprise an axis of light incoupling. The one or more light sources may especially be positioned such that they provide light source radiation with an optical axis. The optical axis of the light source light when it is coupled into the lightguide body may define the axis of light incoupling. In certain embodiments, the axis of light incoupling may be configured parallel to the axis of elongation A_{LB}. In other embodiments, the axis of light incoupling may be configured at an angle to the axis of elongation A_{LB}.

In certain embodiments of the present invention, the lightguide body arrangement may provide at least part of the reactor chamber wall. Such embodiments and their specifications will be described in the following paragraphs.

In certain embodiments, the lightguide body may provide at least part of the reactor chamber wall. In other embodiments, a light transmissive window may provide at least part of the reactor chamber wall. Such parts of the reactor chamber wall may especially be the reactor chamber wall parts configured parallel to the chamber cross-sectional plane P_{C}. The other parts of the reactor chamber wall may in such embodiments not be transmissive to light source light, such as being absorptive or reflective to light source light, especially reflective (like from metal material). Hence, the reaction chamber may be illuminated by light source radiation emanating from at least one or more of the reactor chamber walls. Especially, in embodiments with at least two lightguide body arrangements, the reaction chamber may be illuminated by light source radiation emanating from opposite reactor chamber wall parts.

In embodiments wherein the lightguide body arrangement or the light transmissive window provide at least part of the reactor chamber wall, the first lightguide part may have a circular cross-sectional shape. In other embodiments, wherein the lightguide body arrangement or the light transmissive window provide at least part of the reactor chamber wall, the first lightguide part may have a polygonal cross-sectional shape. For such embodiments, the circular or polygonal cross-sectional shape may be parallel to the axis of elongation A_{LB} and thereby the chamber cross-sectional plane P_{C}. Such a circular or polygonal cross-sectional shape may provide an incoupling surface suitable for a plurality of light sources. A circular cross-sectional shape may especially provide an incoupling surface particularly suitable for (a plurality of) light sources comprised by a flexible PCB, whereas a polygonal cross-sectional shape may especially provide an incoupling surface particularly suitable for (at least one or more) light sources comprised by a rigid PCB.

Such configuration wherein the first lightguide part comprises a circular cross-sectional shape or a polygonal cross-sectional shape may be particularly applicable for embodiments wherein the reaction chamber has essentially a round (polygonal) cross-sectional shape, such as e.g. may be the case for spinning disk reactors. The second lightguide part may thereby comprise a similar round (polygonal) cross-sectional shape as the reaction chamber. Especially, the light escape face may comprise a similar round (polygonal) cross-sectional shape as the reaction chamber. In embodiments, the lightguide body may further comprise a similar round (polygonal) shape as the reaction chamber. Especially, the lightguide body may in such embodiments comprise a flat (polygonal) disk shape. Such configuration may facilitate outcoupling of light source radiation evenly across the reaction chamber via the light escape face.

In further embodiments, wherein the lightguide body arrangement provides at least part of the reaction chamber wall, the photoreactor assembly may comprise at least two lightguide body arrangements. Herein, the reactor chamber wall may comprise a first wall part and a second wall part, both of which may be positioned parallel relative to the chamber cross-sectional plane P_{C}. As such, in the case of a spinning disk reactor, the spinning disk and the first fluid may be configured between the first wall part and the second wall part. Hence, the first wall part and the second wall part may define a chamber height (H_{C}) of the reaction chamber. Each of the first wall part and the second wall part may comprise at least part of one of the respective two lightguide body arrangements. In certain embodiments, each of the first wall part and the second wall part may comprise at least part of one of the respective two lightguide bodies. In other embodiments, each of the first wall part and the second wall part may comprise at least part of one of the respective two light transmissive windows. In yet further embodiments, one of the first wall part and the second wall part may comprise at least part of one of the lightguide bodies, and the other of the first wall part and the second wall part may comprise at least part of a light transmissive window. Hence, the reaction chamber may be illuminated by light source radiation emanating from at least two or more of the reactor chamber walls positioned opposite each other. This configuration may provide particularly good illumination of the reaction chamber.

In other embodiments of the present invention, the lightguide body arrangement may penetrate the reactor chamber wall at least partly into the reactor chamber. Such embodiments and their specifications will be described in the following paragraphs.

The lightguide body arrangement may in embodiments at least partly or fully penetrate the reaction chamber. Especially, in such arrangement, the lightguide body may have an axis of elongation A_{LB} configured parallel to the chamber cross-sectional plane P_{C}. The lightguide body may in such embodiments comprise at least part of a lightguide bar, or a disk, or a fiber, or a rod. Moreover, the lightguide body may in such embodiments comprise an entire lightguide bar, or a disk, or a fiber, or a rod.

Hence, in certain embodiments, the second lightguide part may be in (direct) contact with the reaction chamber and provide the light escape face. In other embodiments, the lightguide body may be at least partly enclosed by a light transmissive window, and such light transmissive window may then provide the light escape face.

In certain embodiments, the lightguide body arrangement may partly penetrate the reaction chamber at a (single) wall position. Hence, this configuration may provide illumination of the reaction chamber emanating from within a specific location of the reaction chamber. In other embodiments, the lightguide body arrangement may penetrate the reactor chamber wall at two wall positions. As such, the lightguide body arrangement may in some embodiments fully penetrate the reaction chamber. In other embodiments, one or more lightguide body arrangements may partly penetrate the reaction chamber. Hence, this configuration may provide illumination of the reaction chamber emanating from across a distance within the reaction chamber, especially a distance equal to the diameter of the reaction chamber. Additionally, the light source light may in such embodiments be outcoupled evenly across the lightguide body as two light source arrangements provide light source light.

The lightguide body arrangement may in embodiments be configured to facilitate even outcoupling of light source light into the reactor chamber. Such configuration may ensure sufficient illumination throughout the reactor chamber, which may hence improve the efficiency of the photocatalytic reaction. Various means of achieving even outcoupling of light source light from the lightguide body arrangement into the reactor chamber may be available in different embodiments, which will be discussed below.

The surface of the second lightguide part may be smooth in specific embodiments. This may depend on achieving sufficient illumination of the reaction chamber to drive the photocatalytic reaction. This may be achieved via one or more of (i) providing sufficient light outcoupling surface and (ii) a relatively small difference in the refractive index between the lightguide body arrangement and the first fluid in the photochemical reaction chamber. Providing sufficient light outcoupling surface may depend on the specific configuration of the lightguide body arrangement in embodiments, it may especially depend on the surface area provided by the light escape face for light outcoupling. Such configurations may be described above for embodiments wherein the lightguide body arrangement may provide at least part of the reaction chamber wall or wherein the lightguide body arrangement at least partly penetrates into the reaction chamber.

The relatively small difference in refractive index between two elements in optical contact may at least partly determine how much of light source radiation may be refracted when escaping from one material into the other. A small difference in index of refraction may facilitate outcoupling but may also lead to less total internal reflection; a large difference may reduce outcoupling, but may promote total internal reflection. In embodiments, a the relatively small difference in refractive index may e.g. be selected from the range of 0.01-0.3, especially between 0.01-0.2, moreover between 0.01-0.1. The relevant refractive index may depend in the context of the present invention on (a) the refractive index of the material defining the light escape face, and (b) the refractive index of the first fluid in the reaction chamber. Especially, in embodiments the refractive index of the first fluid in the reaction chamber may be higher than the refractive index of the material comprising the light escape face. In embodiments, the difference in refractive index may be at least 0.1, such as selected from the range of 0.1-0.3. However, the invention is not limited to such embodiments.

The refractive index of the material comprising the light escape face may in embodiments be either the lightguide body, especially the second lightguide body part, or a light transmissive window. In certain embodiments the refractive index of the material comprising the light escape face may be a static property that does not change between operational modi. Of course, the refractive index of the material comprising the light escape face may adjust depending on the wavelength of the light source light provided by the light source arrangement. Especially, however, herein the index of refraction may be defined at the standard wavelength of 589 nm.

The refractive index of the first fluid may primarily depend on the specific properties and parameters of the first fluid, such as the one or more reactants, the one or more reactant concentrations, and one or more additives (such as e.g. catalyst). In certain embodiments, the refractive index of the first fluid may be static, such as when essentially the same photochemical reaction is repeated between operational modi of the photoreactor assembly. In other embodiments, the refractive index of the first fluid may be dynamic, such as when different photochemical reactions are performed between operational modi of the photoreactor assembly. The refractive index of the first fluid may additionally be affected by conditions during operation of the photoreactor assembly and may hence change over the course of operation. Such parameters may comprise a temperature of the first fluid, a flow of the first fluid, one or more reactant concentrations of the first fluid, and additives to the first fluid. Such additives may e.g. be inert.

For certain embodiments, (i) providing sufficient light outcoupling surface and (ii) a small difference in the refractive index between the lightguide body arrangement and the first fluid in the photochemical reaction chamber, may not be feasible or efficient for all potential photochemical reactions that may be executed by the photoreactor assembly. Such embodiments may incorporate elements or structures that facilitate outcoupling of light source radiation into the reaction chamber, hence achieving sufficient illumination of the reaction chamber or greater efficiency of light source radiation outcoupling.

In (other) embodiments, the second lightguide part may comprise light outcoupling structures (or “light outcoupling elements”). Such light outcoupling structures may be configured to facilitate outcoupling of the light source radiation via the second lightguide part and the light escape face. The light outcoupling structures may be comprised by the light transmissive material of the second lightguide part and may be configured at the light escape face. In other embodiments, the light outcoupling structures may be comprised by the light transmissive material of the light transmissive material of the light transmissive window and may be configured at the light escape face. Such light outcoupling structures may be selected from the group comprising bulk light outcoupling structures and surface light outcoupling structures. Hence, a combination of a relatively large index of refraction difference and light outcoupling structures may facilitate total internal reflection as well as light outcoupling. In this way, it may be possible to couple the radiation out over a relatively large area (of especially the lightguide body).

Bulk light outcoupling structures may be structures embedded by the light transmissive material of the lightguide body. Such bulk light outcoupling structures may comprise particles embedded in the light transmissive material of the lightguide body. Such particles may be scattering particles (like e.g. comprising one or more of Al₂O₃, BaSO₄ and TiO₂ (and optionally voids or “bubbles”). Surface light outcoupling structures may be structures extending out of the light transmissive material of the lightguide body at a face of the lightguide body and/or indentations at the surface. Such surface light outcoupling structures elements may comprise structures at one or more faces of the lightguide body, like indentations, scratches, grooves, dots of material, light scattering structures (in optical contact with the light escape face), etc. Light outcoupling structures are for instance described in WO9922268, WO2012059866, WO2018041470, and WO03027569, which are (each) herein incorporated by reference. The (surface) light outcoupling structures may be configured as a regular pattern of light outcoupling structure. The light outcoupling structures may especially be configured to couple the light source radiation out from the lightguide body, such that an intensity of the light source radiation may escape from the lightguide body relatively evenly distributed over the lightguide body.

In certain embodiments, wherein the lightguide body is in (direct) contact with the reaction chamber and the light escape face is comprised by the lightguide body, either by providing part of the reaction chamber wall or by at least partly penetrating into the reaction chamber wall, a sufficient level of outcoupling of light source radiation into the reaction chamber may be achieved without the incorporation of light outcoupling structures via (i) providing sufficient light outcoupling surface and (ii) a (relatively) small difference in the refractive index between the lightguide body arrangement and the first fluid in the photochemical reaction chamber. In other such embodiments however, light outcoupling structures may be required in order to achieve the desired level of outcoupling of light source radiation into the reaction chamber. Hence, bulk light outcoupling structures may be applied to the lightguide body, especially the second lightguide part, and/or surface light outcoupling structures may be applied to the lightguide body, especially the light escape face.

In other embodiments wherein the lightguide body is at least partly encapsulated by a light transmissive window and the light escape face is at least partly comprised by such light transmissive window, either by providing part of the reaction chamber wall or by at least partly penetrating into the reaction chamber wall, a sufficient level of outcoupling of light source radiation into the reaction chamber may be achieved without the incorporation of light outcoupling structures via (i) providing sufficient light outcoupling surface and (ii) a small difference in the refractive index between the lightguide body arrangement and the first fluid in the photochemical reaction chamber. In other embodiments however, light outcoupling structures may be required in order to achieve the desired level of outcoupling of light source radiation into the reaction chamber. Hence, bulk light outcoupling structures may be applied to the light transmissive window, and/or surface light outcoupling structures may be applied to the light transmissive window, especially the light escape face. In such embodiments, light outcoupling structures may not be incorporated in or on the lightguide body.

The surface of the first lightguide part may comprise an anti-reflective coating, especially where the radiation of the light source is received. However, part of the lightguide body may also comprise a reflective coating, in order to prevent outcoupling of the radiation at parts where outcoupling is not desired (see also below for a possible embodiment).

In certain embodiments, the light source arrangement may be connected to the lightguide body arrangement via fiber-glass connection. The fiber-glass connection may comprise glass fibers, e.g. with a diameter selected from the range of 3-100 μm, such as 4-75 μm, especially 5-50 μm. In certain embodiments wherein the one or more light sources comprise a laser, such as especially a diode laser, the fiber-glass connection may comprise may especially comprise glass fibers with a diameter selected from the range of 3-25 μm, such as 4-20 μm, especially 5-15 μm. In other embodiments wherein the one or more light sources comprise a LED, the fiber-glass may comprise glass fibers with a diameter of at least 15 μm, such as at least 20 μm, especially at least 25 μm. Especially, when the one or more light sources comprise a LED, the glass fibers may be positioned in close proximity to the one or more LEDs, such as a maximum of 5 mm distance between the LEDs and the glass-fiber connection, especially a maximum of 3 mm distance, moreover a maximum of 1 mm distance.

In embodiments of the photoreactor assembly, further features may be incorporated to facilitate outcoupling of the light source radiation into the reaction chamber and hence achieve the desired level of illumination in the reaction chamber during operation. For example, in certain embodiments, the second lightguide part may comprise a slanted face configured to facilitate light source radiation outcoupling from the second lightguide part. The slanted face may comprise an angle relative to the chamber cross-sectional plane P_{C}. This angle may provide for the outcoupling of light source radiation at an angle from the second lightguide body. Light source radiation may outcouple from the second lightguide part comprising the slanted face via an opposite face into the reaction chamber. Especially, the opposite face may comprise the light escape face. In embodiments, the slanted face may thusly provide for a better distribution of the escape of light source radiation across the surface area of the light escape face into the reaction chamber.

Such a slanted face may in embodiments comprise an angle selected from the range of 2°-40° relative to the to the chamber cross-sectional plane P_{C}. Further, the slanted face may comprise an angle selected from the range of 5°-40° relative to the chamber cross-sectional plane P_{C}, such as 5°-35°. In embodiments, the slanted face may comprise an angle selected from the range of 7°-35° relative to the chamber cross-sectional plane P_{C}, especially 7°-30°. Moreover, the slanted face may comprise an angle selected from the range of 10°-30° relative to the chamber cross-sectional plane Pc, such as 10°-25°.

Such embodiments with a slanted face, may further comprise a reflective element. Such a reflective element may be reflective for at least part of the light source radiation. Especially, the reflective element may be reflective for all the light source radiation. In specific embodiments, this may especially comprise a reflective element from reflective materials such as metal materials or Teflon-like material or an oxide coating, like MgO, TiO₂, or a BaSO₄ coating, or a layered combination of metals and dielectric materials, like Al, Ag, or SiO₂. Further, such a reflective element may be configured downstream of the slanted face. Thereby the reflective element may be configured to reflect light source radiation that escaped via the slanted face. The reflected light source radiation may be reflected back into the lightguide body, especially the second lightguide part. Especially, the reflected light source radiation may be reflected back into the second lightguide part via the slanted face. There it may be transmitted through the lightguide body, especially the second lightguide part, and may hence be allowed to outcouple via the light escape face into the reaction chamber. Hence, the light source radiation may be outcoupling into the reaction chamber more efficiently and with better distribution across the surface area of the light escape face. To facilitate this, in embodiments the reflector element may be placed facing and following the contour of the slanted face. In specific embodiments, the reflective element may be in physical contact with the slanted face. Hence, in specific embodiments the reflective element may have a shape similar to the shape of the slanted face. For instance, the reflective element may have a shape supplementary to at least part of the slanted face. As indicated above, the reflective element may be a reflective coating on the slanted face.

Hence, the reflective element may allow the light generating system to redirect light source radiation that would otherwise escape into a part of the photoreactor assembly other than the reaction chamber (such as e.g. the reaction chamber wall) and may instead add to light source radiation that escaped the lightguide body arrangement through the light escape face. This may facilitate more efficient illumination of the reaction chamber, and hence may result in decreased energy cost or increased light output.

Further such embodiments with a slanted face, which may or may not comprise a reflective element, may also be comprised by embodiments with at least two reaction chambers and at least two lightguide body arrangements or a plurality of lightguide body arrangements. Herein, the two lightguide body arrangements or plurality of lightguide body arrangements may be configured between two reaction chambers. The second lightguide parts of both lightguide body arrangements may each comprise such slanted face as described above. The slanted faces may be configured parallel to each other but at an angle compared to the chamber cross-sectional plane Pc as described above. In certain embodiments, the two slanted faces may each have a reflective element configured downstream of the two slanted faces. In specific embodiments, the two slanted faces may share one reflective element (reflective at both sides of the reflective element) configured between and downstream of the two slanted faces.

As indicated above, the at least one or more light source arrangements may be configured to provide the light source radiation into the two reaction chambers via the at least two lightguide body arrangements or the plurality of lightguide body arrangements.

Especially, the at least one or more light source arrangements may provide light source radiation into one of the reaction chambers via a respective one of the second lightguide parts of one of the lightguide body arrangements, and may additionally provide light source radiation into the other one of the reaction chambers via a respective other one of the second lightguide parts of the other one of the lightguide body arrangements. Hence, at least one or more light source arrangements may provide light source radiation for two reaction chambers simultaneously via such configuration of lightguide body arrangements.

The photoreactor assembly may comprise a plurality of light source arrangements and a plurality of lightguide body arrangements. In such embodiments, the photochemical reactor may comprise (i) a plurality of reactor chambers, functionally coupled to each other, and in the case of a spinning disk reactor, (ii) a plurality of spinning disks. The photoreactor assembly may hence comprise a plurality of units. Each unit may comprise (i) one or more of the reactor chambers, (ii) one or more of the lightguide body arrangements configured in a light-receiving relationship with the one or more reactor chambers, and (iii) in the case of a spinning disk reactor, one or more of the spinning disks at least partly configured in the reaction chamber. Such embodiments may facilitate performing different (photo)chemical reactions simultaneously, or performing the same (photo)chemical reaction in large quantities in multiple units. In further embodiments, the photoreactor assembly may further comprise a fluidic system comprising one or more reactor channels connecting the plurality of reactor chambers. In such embodiments, the fluid system may facilitate a multi-step (photo)chemical reaction taking place in different reactor channels.

In such embodiments, the control system may be configured to individually control the spectral power distribution of the light source light of the respective light source arrangements of the plurality of units. In such embodiments, the multi-step (photo)chemical reaction may be exposed to light source light with different spectral power distribution. Hence, different (photo)chemical reaction steps may be exposed to optimized (photo)chemical conditions.

In a further aspect, the invention provides a method for treating a first fluid with light source radiation. In embodiments, the method may comprise providing the first fluid to be treated with light source radiation in embodiments of the photochemical reactor of the photoreactor assembly described above. Further, the method may comprise irradiating the first fluid with the light source radiation. Especially, the first fluid comprises a liquid.

In such embodiments, the method may comprise transporting the first fluid through the photochemical reactor. Especially, the first fluid may be irradiated with the light source radiation. Further, one or more of the light source radiation of the plurality of light sources may be controlled. In the case of a spinning disk reactor, a rotational speed of the spinning disk may also be controlled. Moreover, a refractive index of the first fluid may be controlled. As described above, the refractive index of the first fluid may affect the outcoupling of light source radiation from the lightguide body arrangement into the reaction chamber. This controlling of the refractive index of the first fluid may be achieved by controlling various parameters that may affect the refractive index of the first fluid. Such parameters may comprise a temperature of the first fluid, a flow of the first fluid, one or more reactant concentrations of the first fluid, and additives to the first fluid. Hence, the method may comprise controlling various parameters involved in the (photochemical) reaction of the first fluid for an efficient outcome of the reaction.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system. Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In further embodiments, the method may comprise providing the fluid to be irradiated to the photoreactor assembly comprising a plurality of light source arrangements as described above. In such embodiments, the photoreactor assembly may comprise a fluidic system comprising one or more reactor channels connecting the plurality of reactor chambers through which the fluid may be provided.

In further embodiments, the photoreactor assembly may comprise one or more light source arrangements; wherein the photochemical reactor comprises and one or more reaction chambers (which may be functionally coupled to each other when there are a plurality of reaction chambers), wherein the photoreactor assembly comprises one or more of units, wherein each unit comprises one of the one or more lightguide body arrangements and one of the one or more reactor chambers.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-D schematically depicts embodiments of a photoreactor assembly.

FIG. 2 schematically depicts cross-sections of embodiments of lightguide body arrangements.

FIG. 3 schematically depicts embodiments of a photoreactor assembly with units.

The schematic drawings are not necessarily to scale.

### DETAILED DESCRIPTION OF THE EMBODIMENTS

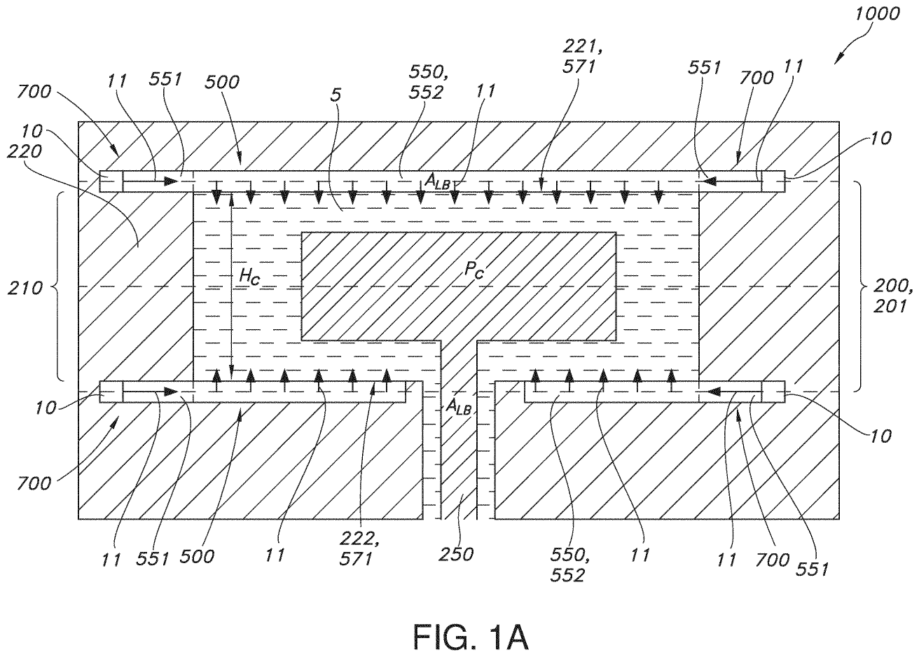

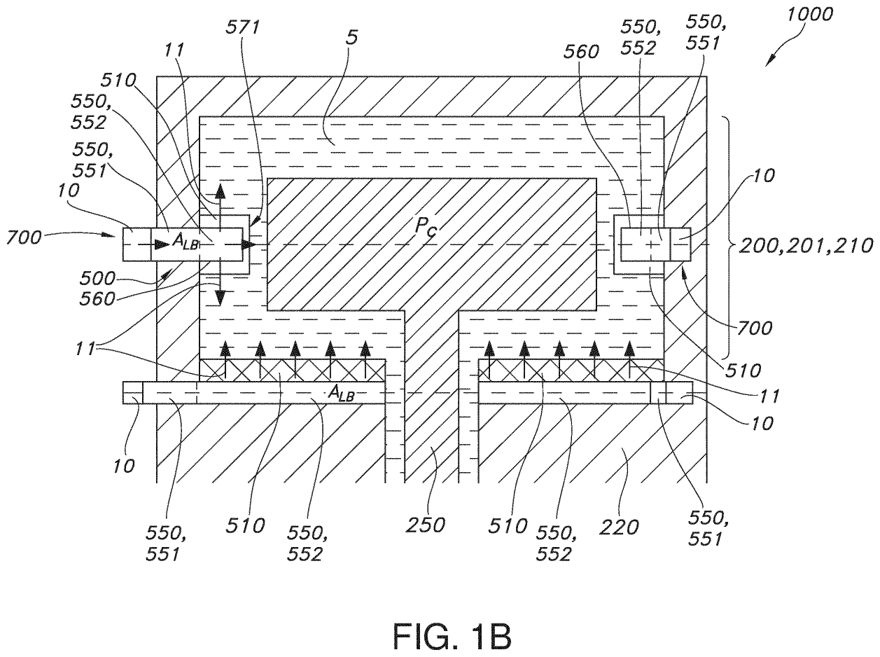

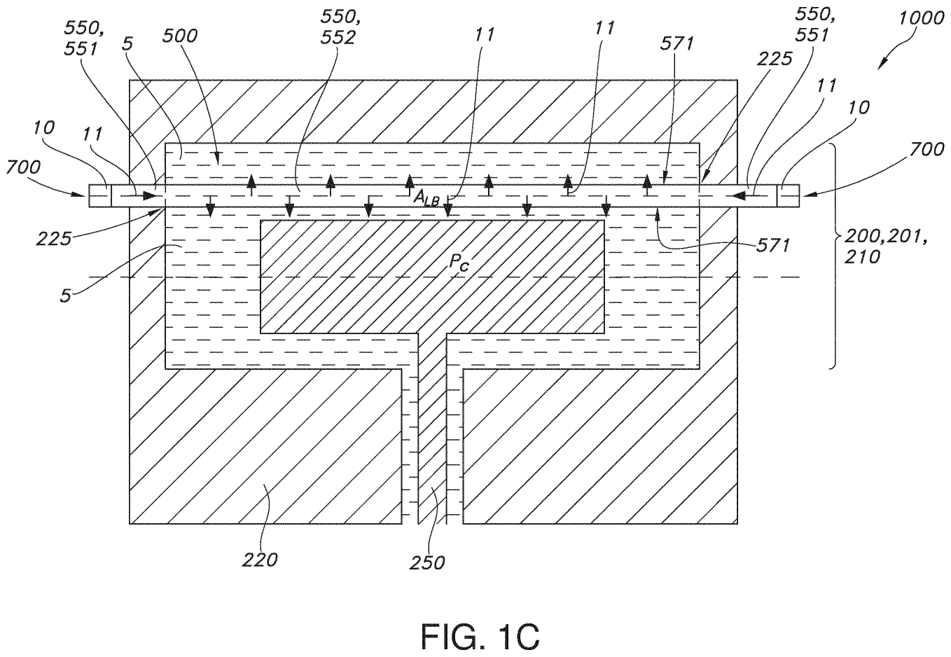

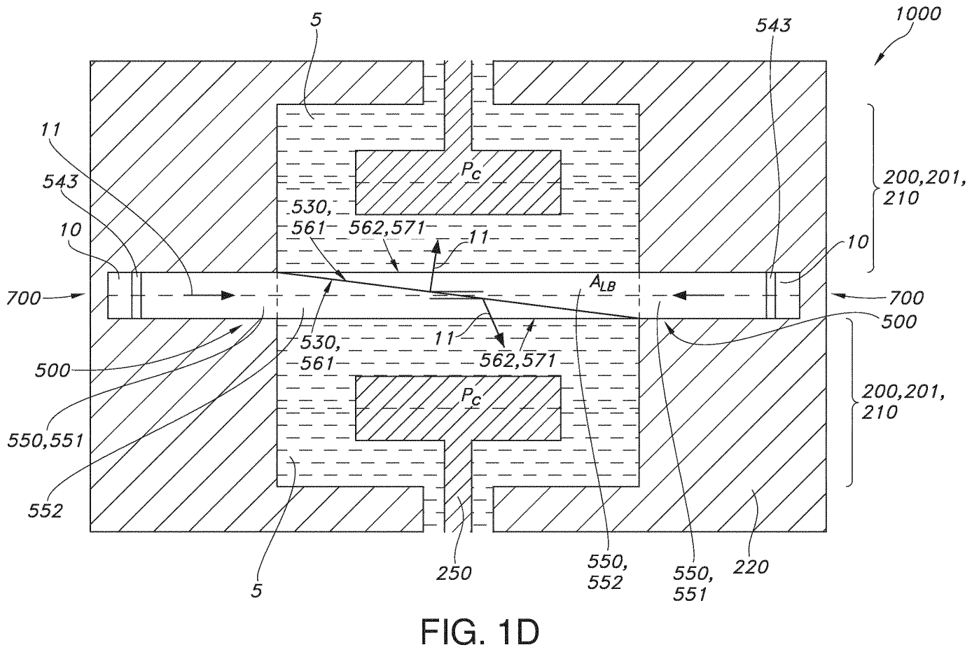

FIG. 1A-D schematically depict embodiments of a photoreactor assembly 1000 comprising (i) a light source arrangement 700, (ii) a photochemical reactor 200, and (iii) a lightguide body arrangement 500. In embodiments, the light source arrangement 700 comprises one or more light sources 10. Further, the one or more light sources 10 are configured to generate light source radiation 11 selected from one or more of UV radiation, visible radiation, and IR radiation. In embodiments, the lightguide body arrangement 500 comprises a lightguide body 550 and a light escape face 571. The lightguide body 550 further comprises a first lightguide part 551 and a second lightguide part 552. The lightguide body 550 and the light source arrangement 700 are especially configured such that at least part of the light source radiation 11 that enters the lightguide body 550 via the first lightguide part 551 escapes from the lightguide body 550 via the second lightguide part 552. The light escape face 571 is either (a) configured downstream of the second lightguide part 552 or (b) is comprised by the second lightguide part 552. In embodiments, the photochemical reactor 200 comprises a reactor chamber 210 configured to host a first fluid 5 to be treated with the light source radiation 11. The photochemical reactor 200 further comprises a reactor chamber wall 220 enclosing at least part of the reactor chamber 210. The photochemical reactor 200 comprises a spinning disk reactor 201. Such a spinning disk reactor 201 especially comprises a disk 250 at least partly configured in the reactor chamber 210. In embodiments, the second lightguide part 552 of the lightguide body arrangement 500 (a) penetrates the reactor chamber wall 220 at least partly into the reactor chamber 210 or (b) provides part of the reactor chamber wall 220.

FIG. 1A-D further depict embodiments of the photoreactor assembly 1000 wherein the reactor chamber 210 comprises a chamber cross-sectional plane P_{C}. Further, the lightguide body arrangement 500 comprises an axis of elongation A_{LB} configured parallel to the chamber cross-sectional plane P_{C}.

FIG. 1A depicts embodiments of the photoreactor assembly 1000 wherein the second lightguide part 552 provides part of the reactor chamber wall 220. The light escape face 571 is comprised by the second lightguide part 552. In such embodiments, the photoreactor assembly 1000 comprises two lightguide body arrangements 500. The reactor chamber wall 220 comprises a first wall part 221 and a second wall part 222 defining a chamber height H_{C} of the reaction chamber 210. The first wall part 221 and the second wall part 222 are both configured parallel to the chamber cross-sectional plane P_{C}. Herein, the disk 250 is configured between the first wall part 221 and the second wall part 222. Especially, each of the first wall part 221 and the second wall part 222 comprise part of one of the respective two lightguide body arrangements 500. Hence, in embodiments, the light escape face 571 may be configured downstream of the second lightguide part.

FIG. 1B depicts embodiments of the photoreactor assembly 1000 wherein at least two second lightguide parts 552 both penetrate the reactor chamber wall 220 at least partly into the reactor chamber 210 and provide part of the reactor chamber wall 220. The light escape face 571 is configured downstream of the second lightguide part 552. Especially, at least one of the lightguide body arrangements 500 penetrates the reaction chamber wall 220 at least partly into the reactor chamber 210. The lightguide body arrangements 500 are shielded from the reactor chamber 210 by a light transmissive window 510. The second lightguide part 552 of the lightguide body 550 comprises at least part of a lightguide bar. Another of the lightguide body arrangements 500 provides part of the reactor chamber wall 220.

Reference 560 refers to a cavity, see further also below. Reference 510 refers to window, transmissive for the light source radiation 11. Note that the reactor chamber wall 220 may thus in embodiments essentially consist of light non-transmissive material, like e.g. steel, but the light guide body arrangement 500 may penetrate the reactor chamber wall 220 and/or part of the reactor chamber wall 220 may be transmissive, and upstream thereof the lightguide body 550 may be configured.

FIG. 1C depicts embodiments of the photoreactor assembly 1000 wherein the second lightguide part 552 penetrates the reactor chamber wall 220 at least partly into the reactor chamber 210. The light escape face 571 is comprised by the second lightguide part 552. Especially, the lightguide body arrangement 500 penetrates the reactor chamber wall 220 at two wall positions 225 and fully penetrates the reaction chamber 210. Especially, the second lightguide part 552 of the lightguide body 550 comprises at least part of a lightguide bar.

FIG. 1D depicts embodiments of the photoreactor assembly wherein the second lightguide part 552 both penetrates the reactor chamber wall 220 at least partly into the reactor chamber 210 and provides part of the reactor chamber wall 220. The light escape face 571 is comprised by the second lightguide part 552. The first lightguide part 551 comprises light incoupling structures 543. Especially, the second lightguide part 552 comprises a slanted face 561 configured to facilitate light source radiation 11 outcoupling from the second lightguide part 552 via an opposite face 562 into the reaction chamber 210. Depicted embodiments further comprise a reflective element 530, that may be reflective for light source radiation 11, configured downstream of the slanted face 561. Such reflective element 530 is configured to reflect light source radiation 11 that escaped via the slanted face 561 back into the second lightguide part 552 via the slanted face 561. The embodiments of the photoreactor assembly 1000 comprise two reaction chambers 210 and two lightguide body arrangements 500. Herein, the two lightguide body arrangements 500 are configured between the two reaction chambers 210. The second lightguide parts 552 of both lightguide body arrangements 500 each comprise such slanted face 561. Further, the slanted faces 561 are configured parallel optionally with the reflective element 530 configured in between the two slanted faces 562. Especially, the light source arrangement 700 and the two lightguide body arrangements 500 are configured to provide the light source radiation 11 into one of the reaction chambers 210 via one of the second lightguide parts 552 and into the other one of the reaction chambers 210 via the other one of the second lightguide parts 552.

Referring to FIGS. 1a-1d, in specific embodiments, the lightguide body arrangement essentially consists of the lightguide body, such as schematically depicted in FIGS. 1a, 1c, and 1d, though in other embodiments, there may e.g. be a further window 510, see FIG. 1b. For instance, at least part of the lightguide body may be configured in a cavity, indicated with reference 560. Such cavity may comprise a cavity wall which may be transmissive for at least part of the radiation escaping from the lightguide body. Hence, such cavity 560 may at least partly be defined by a transmissive window 510. The present solution allows the reactor chamber wall 220 not to be necessarily light transmissive for the light source radiation 11 but allows the reactor chamber wall 220 to be from a material like aluminum, or other material, which is not necessarily transmissive for the light source radiation 11. In this way, the reactor chamber wall 220 may be optimized for the reaction conditions and/or in view of mechanical aspects, whereas with the presence of the of a lightguide body arrangement 500, a (relatively) small part of the reactor wall 220 may be penetrated by the lightguide body arrangement, or a (relatively) small part of the reactor wall 220 may be penetrated by the lightguide body arrangement, and the light guide body 550 may be configured in a cavity 560 (at least partly defined by a transmissive window 510), or a (relatively) small part of the reactor wall 220 may be replaced by the lightguide body arrangement 500, or a (relatively) small part of the reactor wall 220 may be replaced by the lightguide body arrangement 500 including a window 510 configured downstream of at least part of the light guide body 550. Hence, in embodiments, the lightguide body 550 may provide the light escape face 571, whereas in other embodiments, a light transmissive window 510 may provide the light escape face 571. Combination of embodiments may also be applied.

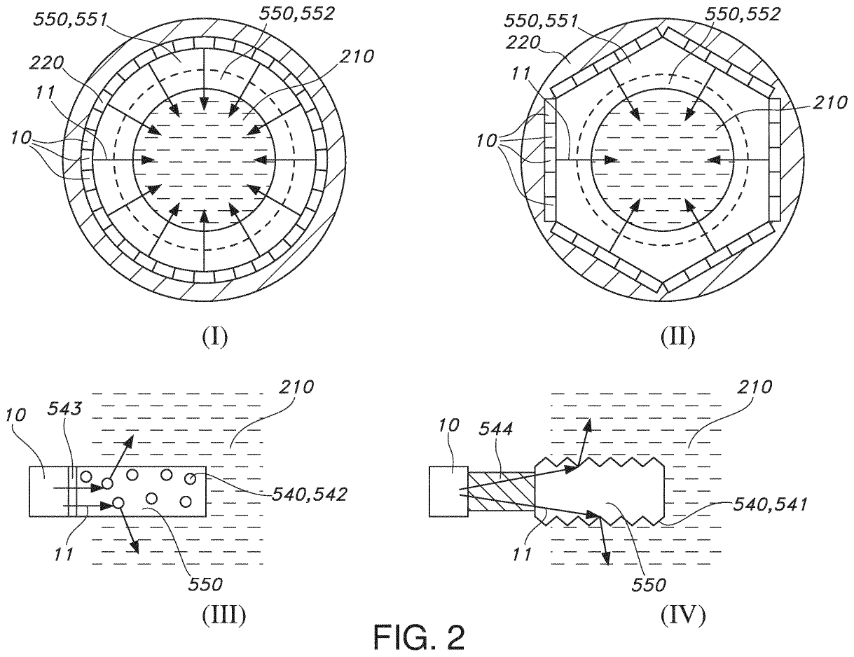

FIG. 2 schematically depicts cross-sections of embodiments of lightguide body arrangements 500. Embodiments I and II display top-down views of the photoreactor assembly 1000. In embodiment I, the second lightguide part 552 provides part of the reactor chamber wall 220, and the first lightguide part 551 has a circular cross-sectional shape parallel to the chamber cross-sectional plane P_{C}. In embodiment II, the second lightguide part 552 provides part of the reactor chamber wall 220, and the first lightguide part 551 has a polygonal cross-sectional shape parallel to the chamber cross-sectional plane P_{C}. Embodiments III and IV display cross-sectional views of the lightguide body arrangement 500 in the photoreactor assembly 1000. In embodiment III, the second lightguide part 552 penetrates the reactor chamber wall 220 at least partly into the reactor chamber 210, and the second lightguide part 552 comprises light outcoupling structures 540 selected from bulk light outcoupling structures 542. Embodiment III further comprises incoupling structures 543 such as especially anti-reflective coating. In embodiment IV, the second lightguide part 552 penetrates the reactor chamber wall 220 at least partly into the reactor chamber 210, and the second lightguide part 552 comprises light outcoupling structures 540 selected from surface light outcoupling structures 541. Embodiment IV further comprises a fiber-glass connection 544 between the light source 10 and the lightguide body 550.

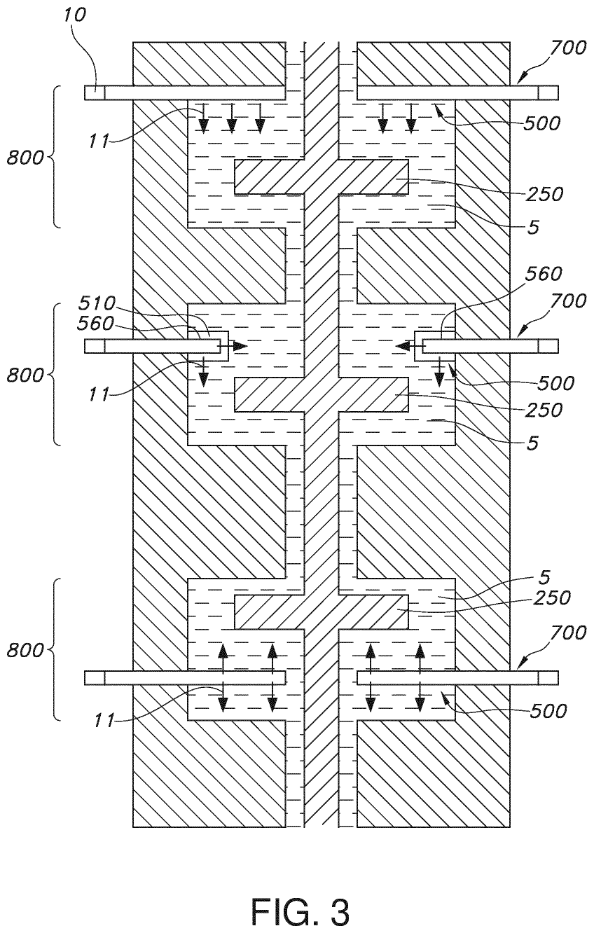

FIG. 3 schematically depicts embodiments of a photoreactor assembly 1000 with units 800. The photoreactor assembly 1000 comprises a plurality of light source arrangements 700 and a plurality of lightguide body arrangements 500. The photochemical reactor 200 comprises (i) a plurality of reactor chambers 210, functionally coupled to each other, and (ii) a plurality of disks 250. Especially, the photoreactor assembly 1000 comprises a plurality of units 800, wherein each unit 800 comprises (i) one of the reactor chambers 210, (ii) one of the lightguide body arrangements 500 configured in a light-receiving relationship with the one of the reactor chambers 210, and (iii) one of the spinning disks 250 partly configured in the one of the reaction chamber 210. Here, by way of example a plurality of embodiments or variants are schematically depicted in the same photoreactor assembly 1000. Of course, this is not necessarily the case.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A photoreactor assembly comprising (i) a light source arrangementm (ii) a photochemical reactor, and (iii) a lightguide body arrangement wherein:
the light source arrangement comprises one or more light sources; wherein the one or more light sources are configured to generate light source radiation selected from one or more of UV radiation, visible radiation, and IR radiation;
the lightguide body arrangement comprises a lightguide body and a light escape face; wherein the lightguide body comprises a first lightguide part and a second lightguide part; wherein the lightguide body and the light source arrangement are configured such that at least part of the light source radiation that enters the lightguide body via the first lightguide part escapes from the lightguide body via the second lightguide part; wherein the light escape face is (a) configured downstream of the second lightguide part or (b) is comprised by the second lightguide part
the photochemical reactor comprises a reactor chamber configured to host a first fluid to be treated with the light source radiation wherein the photochemical reactor comprises a reactor chamber wall enclosing at least part of the reactor chamber wherein the photochemical reactor comprises a spinning disk reactor wherein the spinning disk reactor comprises a disk at least partly configured in the reactor chamber; and
the lightguide body arrangement (a) penetrates the reactor chamber wall at least partly into the reactor chamber or (b) provides part of the reactor chamber wall; and
wherein the light source arrangement is configured outside of the reaction chamber.

2. The photoreactor assembly according to claim 1, wherein the reactor chamber comprises a chamber cross-sectional plane, wherein the lightguide body arrangement comprises an axis of elongation configured parallel to the chamber cross-sectional plane.

3. The photoreactor assembly according to claim 2, wherein the lightguide body arrangement provides part of the reactor chamber wall, wherein the part of the reactor chamber wall is configured parallel to the chamber cross-sectional plane.

4. The photoreactor assembly according to claim 3, wherein the first lightguide part has a circular cross-sectional shape.

5. The photoreactor assembly according to claim 3, wherein the first lightguide part has a polygonal cross-sectional shape.

6. The photoreactor assembly according to claim 3, comprising two lightguide body arrangements, wherein the reactor chamber wall comprises a first wall part and a second wall part defining a chamber height of the reaction chamber both configured parallel to the chamber cross-sectional plane, wherein each of the first wall part and the second wall part comprise part of one of the respective two lightguide body arrangements.

7. The photoreactor assembly according to claim 2, wherein the lightguide body arrangement partly penetrates the reaction chamber.

8. The photoreactor assembly according to claim 2, wherein the lightguide body arrangement penetrates the reactor chamber wall at two wall positions and fully penetrates the reaction chamber.

9. The photoreactor assembly according to claim 1, wherein the second lightguide part comprises light outcoupling structures selected from the group comprising bulk light outcoupling structures and surface light outcoupling structures.

10. The photoreactor assembly according to claim 1, wherein the second lightguide part comprises a slanted face configured to facilitate light source radiation outcoupling from the second lightguide part into the reaction chamber.

11. The photoreactor assembly according to claim 10, further comprising a reflective element, configured downstream of the slanted face, and configured to reflect light source radiation that escaped via the slanted face back into the second lightguide part.

12. The photoreactor assembly according to claim 10, comprising two reaction chambers and two lightguide body arrangements wherein the two lightguide body arrangements are configured between the two reaction chambers; wherein the second lightguide parts of both lightguide body arrangements each comprise such slanted face, wherein the slanted faces are configured parallel, wherein the light source arrangement and the two lightguide body arrangements are configured to provide the light source radiation into one of the reaction chambers via one of the second lightguide parts and into the other one of the reaction chambers via the other one of the second lightguide parts.

13. The photoreactor assembly according to claim 1; wherein
the photoreactor assembly comprises a plurality of light source arrangements and a plurality of lightguide body arrangements wherein the photochemical reactor comprises (i) a plurality of reactor chambers, functionally coupled to each other, and (ii) a plurality of disks;
the photoreactor assembly comprises a plurality of units, wherein each unit comprises (i) one of the reactor chambers, (ii) one of the lightguide body arrangements configured in a light-receiving relationship with the one of the reactor chambers, and (iii) one of the spinning disks partly configured in the one of the reaction chamber

14. A method for treating a first fluid with light source radiation, wherein the method comprises:
providing the first fluid to be treated with the light source radiation in the photochemical reactor of the photoreactor assembly according to claim 1; and
irradiating the first fluid with the light source radiation.

15. The method according to claim 14, further comprising:
transporting the first fluid through the photochemical reactor while irradiating the first fluid with the light source radiation and controlling one or more of (i) the light source radiation of the one or more light sources (ii) the rotational speed of the spinning disk, and (iii) the refractive index of the first fluid.
